(19) United States
(12) Patent Application Publication
(10) Pub. No.: US 2024/0361269 A1
(43) Pub. Date: Oct. 31, 2024

(54) REFERENCE ELECTRODE ASSEMBLY, ELECTRICAL ENERGY STORAGE DEVICE COMPRISING THE REFERENCE ELECTRODE ASSEMBLY AND RELATIVE PRODUCTION METHOD

(71) Applicant: BEDIMENSIONAL S.P.A., Genova (GE) (IT)

(72) Inventors: Hossein BEYDAGHI, GENOVA (GE) (IT); Sebastiano BELLANI, GENOVA (GE) (IT); Beatrice LAURENTI, GENOVA (GE) (IT); Marilena Isabella ZAPPIA, GENOVA (GE) (IT); Francesco BONACCORSO, GENOVA (GE) (IT)

(21) Appl. No.: 18/140,066

(22) Filed: Apr. 27, 2023

(51) Int. Cl. G01N 27/30; H01M 4/133; H01M 10/42; H01M 10/48

(52) U.S. Cl. CPC G01N 27/301; H01M 4/133; H01M 10/4285; H01M 10/484; H01M 10/0525

(57) ABSTRACT

A reference electrode assembly installable in an electrical energy storage device; the reference electrode comprising a planar main body, which comprises in turn:
a first electronically insulating layer;
a second electronically insulating layer facing and parallel to the first electronically insulating layer;
a planar, porous reference electrode, which is entirely interposed between the first electrically insulating layer and the second electrically insulating layer;
wherein the reference electrode comprises in turn:
a first part of active material, namely a metal ion intercalating/deintercalating material;
a second part of graphene-based conductive component;
a third part of binding component;

### BACKGROUND

### Technical Field

The present disclosure relates to a new reference electrode assembly, a relative electrical energy storage device comprising the reference electrode assembly and a relative production method.

### Description of the Related Art

From an environmental perspective, Li-ion batteries (LiBs) are playing a major role in several markets to reach climate neutrality. Other secondary batteries (e.g., sodium-ion, Li—S and Li-air ones) also represent potential alternatives to LiBs, while reducing the use of critical raw materials (e.g., rare earths, lithium, nickel, manganese, or cobalt).

Beyond the need for high energy density, high power density (which, in turn, also means fast-charging ability) and cost-effectiveness, the quality, reliability, lifetime (QRL) and safety became crucial requirements for specific end-use applications of current battery cells. Conventionally, QRL and safety are evaluated on sample cells, which are removed from the production chain to evaluate each batch, which is assumed to have the same features.

However, such evaluations are unable to verify the health status of individual cells during use, where actual operation may deviate from nominal one. Therefore, research and development efforts are considering the integration of sensing components into battery cells, so that their output data can be used by Battery Management Systems (BMSs) to monitor, through in operando and real-time modes, the key parameters of a battery cell, providing accurate estimates for states of charge, health, power, energy, and safety (SoX) cell indicators, along with other early-failure indicators. This, in turn, enables the BMS to implement corrective actions to protect the cell and battery systems from degradation phenomena and undesired electrochemical side-reactions, preventing dangerous effects, like thermal runaway events and consequent battery fire, and even permitting the possibility to reuse end-of-life batteries in second-life applications.

For example, the overcharging or low-temperature charging of LiBs can decrease the anode potential below the Li/Li+ redox potential, causing Li plating (i.e., Li⁰ deposition at the anode). Since the Li⁰ coalescence is disrupted by insulating solid/electrolyte interphase (SEI) formation, Li plating leads to a first reaction-limited growth of a mossy Li⁰ layer followed by diffusion transport-limited growth of fractal-like Li⁰ dendrites that propagate rapidly until puncturing the separators and contacting the cathode. The latter process, in turn, leads to rapid cell discharge, generating heating and, eventually, triggering the battery runaway. Also, before reaching such drastic cell failure, dendrites can progressively grow until damaging the anode film or breaking into “dead” Li (i.e., Li⁰ disconnected by the rest of the anode). Both these effects cause pronounced capacity fading and low Coulombic efficiencies of the cell.

The SEI formation on both Li⁰ mossy layer and dendrites is associated with electrolyte decomposition, causing severe gassing and, thus, overpressurization. Cathode overcharging can also cause electrolyte decomposition, leading to gassing and cell overpressurization, accompanied by a substantial fade of the ionic conductivity of the electrolyte. In addition, overdischarging phenomena can also occur. For example, when the anode potential increases abnormally during overdischarge; the anode current collector may oxidize (e.g., Cu can oxidize to Cu²⁺). Also, over-metal ion deintercalation (i.e., de-lithiation in LiBs) during anode overdischarge can cause the decomposition of the SEI, generating gases, e.g., CO₂. Because of the decomposition of the SEI layer, subsequent cell charge will be affected by irreversible reactions needed to reform the SEI, causing Coulombic efficiency losses as well as anode morphology/structure modifications. Additionally, side reactions could also occur during the overdischarge of the cathodes, leading to a solid-state amorphization of cathode materials, and thus to an overall cathode capacity degradation.

To eliminate or, at least, mitigate, the above degradation phenomena, the use of reference electrodes to build three-electrode cell configurations has been considered as a potential solution. In fact, thanks to their ideally constant equilibrium potential, reference electrodes can be used to monitor separately the anode and cathode potentials, avoiding the latter to reach critical potential thresholds that initiate irreversible cell failures.

Reference electrodes can be used to monitor the ionic conductivity of the electrolyte and the electrochemical processes of each half-cell through electrochemical impedance spectroscopy (EIS) measurements, enabling the BMS to get information related to the properties of the electrolyte, electrodes, and interfaces thereof in a non-invasive way. EIS is a fast and reliable technique that can identify the origin of cell degradation processes, tracking the changes of the electrolyte, electrodes, and interface thereof by monitoring the evolution of the parameters of the equivalent electric circuit (EEC) used to model the cell.

In general, the EIS spectra can be divided into three regions:
Ohmic high-frequency (typically >1000 Hz) region, in which the real part of the impedance is associated with the internal resistance of the cell;
mid-frequency region (between 1000 Hz and 0.1 Hz), in which charge-transfer processes at electrode/electrolyte interfaces and the interfaces between electrode components give rise to depressed semi-circular arches modelled as parallel RQ circuit (in which R is the charge transfer resistance and Q is the constant phase element associated to the interface);
low-frequency (typically <0.1 Hz) region, in which the diffusion processes at the two electrodes can be also monitored.
   Even though EIS can be also performed directly using the battery's electrode, only three-electrode cell configuration measurements permit to study of the single half-cells separately, permitting discrimination of concomitant degradation processes occurring in both half-cells during the operation of the cell.

Based on the above considerations, several reference electrodes have been designed for monitoring cell indicators (e.g., anode and cathode potentials) in both static (i.e., rest or open circuit voltage (OCV)), and dynamic (i.e., charging or discharging, conditions) and ensuring reliable, artefact-free EIS measurements in various types of battery cell configurations, including coin cells, Swagelok T-cells and pouch cells.

Examples of reference electrodes include:
point-like (e.g., reference electrodes in ECC-Ref electrochemical cell, see also patent Nr.: EP3108224; U.S. Pat. No. 10,408,781B2; CN106030298A)
ring-shaped reference electrodes (e.g., reference electrodes in HS-3E Cell by Hohsen Corp)
coaxial reference electrodes;
wire reference electrodes;

Through the support of finite element method (FEM) simulations combined with experiments, the previously proposed reference electrodes for LiBs result in pronounced artefacts in EIS data (e.g., inductive loops and other impedance spectra distortions), leading to error-prone half-cell impedance measurements and misleading data interpretations.

First, technical aspects related to the reference electrode materials must be considered. In fact, several reported electrodes are made of Li,⁴ e.g., obtained by punching/cutting areas of Li foil (see ECC-Ref electrochemical cell supplied by EL-CELL GmgH) or by depositing a Li⁰ film onto metallic substrates through Li electroplating,⁵ or by other physical methods, such as pasting followed by crimping of Li⁰,⁶ and immersion of metallic substrates in molten Li (patent Nr. US20210135322A1). However, the potential of Li strongly depends on the presence of native passive film or its surface pre-treatment and can be affected by ageing and degrading effects, e.g., irreversible reactions (including SEI formation) and formation of dendrites that have detrimental effects on the other cell components. Moreover, the low melting point of Li metal (˜180° C.) can also represent a potential limitation for high-temperature applications.

Li-containing alloys, e.g., Li—Sn, Li—Al, Li—Bi, Li—Au and Li—Cu, have been proposed as a valuable alternative to Li with stable equilibrium potentials, even though they often require a lithiation process to maintain a chemically stable composition over month-scale periods, recommending proper precautions for their reliable and reproducible use.

Recently, prototypical battery active materials, featuring a well-defined two-phase transition mechanism during Li⁺ intercalation/deintercalation reactions with stable and constant equilibrium potentials, have been proposed as suitable materials for the realization of reliable and durable reference electrodes. These materials include Li-containing oxides (Li₄Ti₅O₁₂ —LTO—) and Li-containing phosphates (e.g., LiFePO₄ —LFP—), including their C-coated forms, and can be deposited onto proper current collectors (e.g., stainless steel, Cu, Al) to form reference electrodes. Pre-conditioning treatments are however recommended also for these types of reference electrodes to obtain phases corresponding to their 50% of the state of charge (SoC), at which the change of potential with SoC variation is typically minimized. Unfortunately, reliable methods to perform the pre-conditioning or restoring of such reference electrodes through in-situ procedures are missing, eventually complicating their integration in battery systems produced through conventional manufacturing procedures.

Second, the design and positioning of reference electrodes are also crucial for their successful operation. For point-like and ring-shaped reference electrodes positioned near the edges of the electrodes, geometric asymmetrics (e.g., misalignment between working and counter electrodes, different sizes of working electrodes and counter electrodes) and electrochemical asymmetries, caused by the different kinetics and/or frequency responses of the working electrode and counter electrodes, are sources of artefacts in EIS measurements.

Noteworthy, electrochemical asymmetry is intrinsically unavoidable in full cells since the anode and cathode clearly show different electrochemical behaviours. In addition, also geometric asymmetries are practically unavoidable in real cells and measurements setups (e.g., shifts of an electrode relative to each other are expected when assembling cells).

Concerning co-axial reference electrodes, artefacts originating from electrochemical asymmetries are also expected. The artefacts can be minimized when the misalignment of the electrodes is small compared to the separator thickness. However, this is a condition hardly ensured by “practical” thin (<400 μm, typically 25 μm) separators, which are required to minimize Ohmic losses associated with the limited conductivities of common electrolytes (on the order of 10 mS/cm), as well as to achieve high specific (gravimetric/volumetric) performances (e.g., capacity, energy, and power densities).

The lateral surface of electrodes must also be “not wetted” by the electrolyte to prevent edge effect-induced artefacts.

Moreover, both the working electrode and counter electrode must have central holes, otherwise radial currents from the un-holed electrode towards the edges of the central holes of the holed electrodes can cause distorted features and inductive loops in the EIS spectra. Clearly, such a geometric constraint is hardly applicable to industrial cell configurations, including pouch, cylindrical and prismatic cells.

In this context, both wire (including encapsulated ones ending with the unencapsulated point-/ring-like region) and mesh electrodes positioned between the two cell electrodes have the potential to eliminate almost completely the effects of common geometric/electrochemical asymmetries.

For the sake of clarity, for mesh reference electrodes (commonly made of metallic meshes coated by Li-containing metal oxides or Li-containing metal phosphates), low thickness, large opening ratio and low impedance are requirements to avoid extra polarization contribution originating from the current pathway through the mesh. Nevertheless, the finite diameter of the wires for both wire and mesh references inevitably leads to local deformations/inhomogeneous compression of the electrodes and separators, leading to stochastic electrochemical effects.

On the other hand, bulky reference electrodes increase the overall cell weight/volume, decreasing the specific (gravimetric/volumetric) performances, i.e., capacity, energy, and power densities, in practical battery systems. In addition, because of their finite diameter, wires (including those of meshes) represent obstacles for the transport of the ions under dynamic conditions. Such an “ion-blocking effect” results in abnormal electrochemical behaviour of the cell, because of inhomogeneous current paths. For example, the electrochemical reactions are slowed down nearby the electrode area masked by the reference electrodes. This, for example, causes abnormal features in the measured electrode potentials during resting time.

Additionally, the ion blocking effect leads to artefacts in the measurements of the anode and cathode potentials with the reference electrodes, e.g., excessive measured anode overpotentials when charging cells to high SoCs with high rates. As to a separator pore closure, the ion-blocking behaviour of a bulky wire (or mesh) implies high local current densities and overpotential of the battery electrodes in the proximity of the wire (mesh) perimeter. This, in turn, can cause local Li plating at the anode or, more in general, overcharging of the electrodes.

For dynamic electrochemical measurements, the Ohmic polarization between the reference electrode and the cell electrodes must also be considered. Therefore, the reference electrode cannot be placed far from the surfaces of the electrodes, recommending its positioning between the anode and the cathode. This aspect excludes the use of several of the above discussed reference electrode configurations for electrochemical measurements under dynamic conditions.

Patent documents EP3108224, U.S. Pat. No. 10,408,781B2, and CN106030298A provide point-like reference electrodes for which geometric asymmetrics (e.g., misalignment between working and counter electrodes, different sizes of working electrodes and counter electrodes) and electrochemical asymmetries, caused by the different kinetics and/or frequency responses of the working electrode and counter electrodes, are sources of artefacts in EIS measurements. Also, such reference electrodes are placed far from the surfaces of the cell electrodes, impeding their use for electrochemical measurements under dynamic conditions.

Patent document U.S. Pat. No. 9,379,418B2 uses Li metal, lithiated carbon, or a variety of other Li-containing electrode materials for producing reference electrodes. In this invention, the reference electrode is directly placed behind a cell electrode, using an additional separator to electronically separate the reference electrode from the adjacent cell electrode. The ion conduction between the reference electrode and the adjacent cell electrode is ensured by using a porous current collector for the cell electrode adjacent to the reference electrode. This method is not compatible with cell design, including pouch, cylindrical and prismatic cells, using double-sided coated cell electrodes. Such cell design features intrinsically reduce the specific (volumetric and gravimetric) performances of the batteries compared to those without reference electrodes. Also, the reference electrode is placed far away from one of the cell electrodes, impeding its use to monitor the potential of both cell electrodes (or to measure both the half-cell impedances).

Patent document U.S. Pat. No. 8,586,222B2 proposes a cluster or array of reference electrode materials to monitor the state of charge of positive and negative active electrode materials of a Li-ion cell. The array of reference electrodes includes at least two electrically discrete instances of reference electrode materials. Such technology requires complex manufacturing processes, and complex wiring of reference electrodes, and complicates the BMSs that must process several signals associated with each reference electrode. Also, the design of reference electrode arrays did not consider the ion blocking effects, which can be deleterious for the implementation of this reference electrode technology in practical applications. Therefore, such an invention significantly differs from the present one.

The purpose of the present invention is to provide a reference electrode assembly, a relative electrical energy storage device comprising the reference electrode assembly and a relative production method, which are at least partially free from the abovementioned drawbacks and, at the same time, is simple and cost-effective to implement.

### BRIEF SUMMARY

In accordance with the present invention, a reference electrode assembly, a relative electrical energy storage device comprising the reference electrode assembly and a relative production method are provided according to what is claimed in the following independent claims and, preferably, in any one of the claims depending directly or indirectly on the independent claims.

The claims describe preferred embodiments of the present invention forming an integral part of this description.

In particular, the present disclosure will refer, without loss of generality, to a graphene-enabled high conductivity, printed, flat, flexible and non-invasive reference electrodes, directly deposited onto a separator (without using any metallic current collector) and electronically insulated from the cell electrodes, for secondary batteries, solving the limitations of previously reported reference electrodes.

The teachings here described refer to traditional LiBs, but one person skilled in the art can directly use them for other types of Li-based batteries (e.g., Li—S batteries and Li-air batteries), or modify them to make them suitable for other battery chemistries (e.g., Na-ion batteries, K-ion batteries, Mg-ion batteries and Ca-ion batteries, among many others).

### BRIEF DESCRIPTION OF THE SEVERAL VIEWS OF THE DRAWINGS

The present disclosure will now be described in detail with reference to the annexed drawings, which represent some non-limiting embodiments, wherein:

FIG. 1 illustrates, schematically and with details removed for clarity, a perspective view of a first embodiment of a reference electrode assembly according to the present invention;

FIG. 2 illustrates, schematically and with details removed for clarity, an exploded perspective view of the embodiment of FIG. 1;

FIG. 3 illustrates, schematically and with details removed for clarity, a perspective view of a second embodiment of a reference electrode assembly according to the present invention;

FIG. 4 illustrates, schematically and with details removed for clarity, an exploded perspective view of the embodiment of FIG. 3;

FIG. 5 illustrates an exploded view of a first embodiment of an electric energy storage device comprising a reference electrode assembly;

FIG. 6 illustrates an exploded view of an embodiment of a planar electric energy storage device (pouch cell stack) comprising a reference electrode assembly;

FIG. 7 illustrates an exploded view of an embodiment of a cylindrical electric energy storage device (cylindrical cell) comprising a reference electrode assembly;

FIG. 8 illustrates a side section view of a further embodiment of an electric energy storage device comprising a reference electrode assembly;

FIG. 9 illustrates a step of a method to produce the reference electrode assembly.

### DETAILED DESCRIPTION

Referring to the attached figures, it is indicated as a whole with 1 reference electrode assembly. In particular, it is indicated reference electrode assembly 1 a reference electrode assembly technology with at least one reference electrode realized on a cell separator and electrically insulated from battery electrodes, and electrically contacted by wiring element for the electrical connection of the reference electrodes to an external circuitry.

In the present disclosure, the same numbers and reference letters in the figures identify the same elements or components with the same function.

In the context of this disclosure, the wording “second” component does not imply the presence of a “first” component. In fact, such terms are used as labels to improve clarity and should not be understood in a limiting way.

The elements and features illustrated in the various preferred forms of embodiment, including drawings, may be combined with each other without, however, falling outside the scope of protection of this application as described below.

Generally speaking, the requirements for a reference electrode are long-term stable equilibrium potentials and non-polarizability, the latter meaning that the corresponding impedance must be minimized. High-impedance reference electrodes can cause DC errors. At DC, modern potentiostats have electrometer input current lower than 100 pA. Thus, according to Ohm's Law, the resistance of the reference electrodes on the order of 10 kΩ are acceptable, since they would cause a DC voltage measurement error on the order of 1 μV (common reference electrode potentials are typically reproducible to ˜1 mV). In AC-mode (e.g., EIS tests), the capacitance of the reference electrode is in series with its electrode resistance. Consequently, the reference electrode can act as a low-pass RC filter, whose RC constant must be maximized to permit wide band operation at frequencies to more than 10 kHz, such as those used in EIS experiments testing battery cells. Beyond these general specifications, a reference electrode for LiBs must not interfere with cell operation, while ensuring accurate monitoring of cathode and anode potentials distinctively in both static and dynamic conditions and artefact-free EIS measurements. The following disclosure will show how reference electrode assembly 1 meets all these requirements.

The reference electrode assembly 1 is installable in an electrochemical energy storage device 2, which, in particular, is a secondary battery, e.g., for consumer electronics or vehicular battery pack.

The reference electrode assembly 1 comprises a first electronically insulating layer 3 and a second electronically insulating layer 4, which are facing and parallel to each other.

In addition, the reference electrode assembly 1 comprises at least one planar, porous reference electrode 5, which is entirely interposed between the first electrically insulating layer 3 and the second electrically insulating layer 4. In other words, the reference electrode 5 is sandwiched between the first electronically insulating layer 3 and a second electronically insulating layer 4.

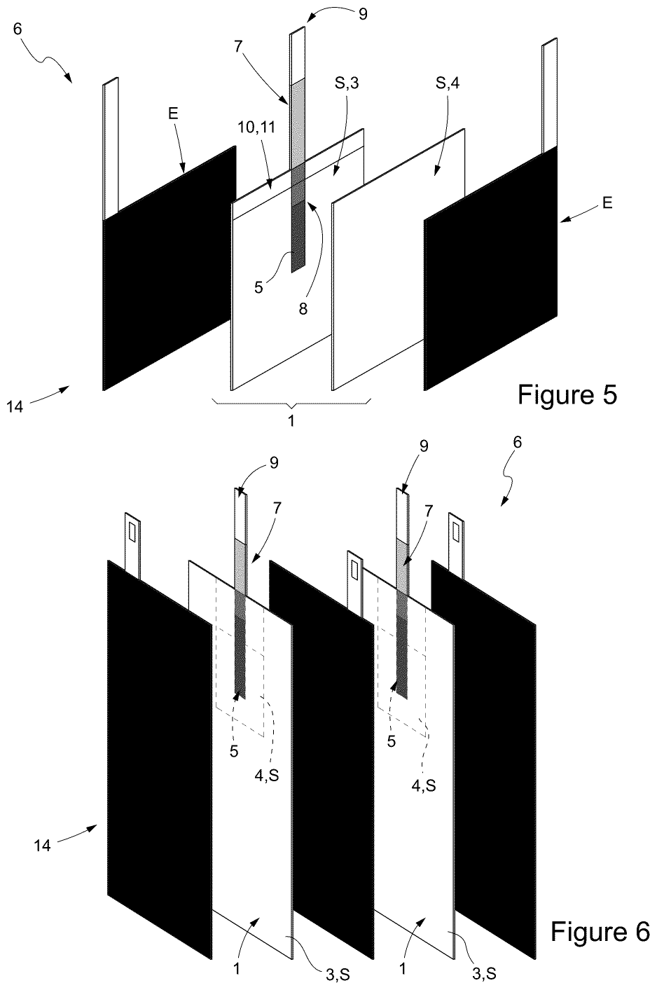

FIGS. 5-8 illustrate the reference electrode assembly 1 integration in electrical storage devices 2, in particular a cell 6 of such a device 2. Cell 6 comprises at least one electrode E and a separator S. Preferably, cell 6 comprises at least two electrodes E (e.g., anode and cathode) and two separators S alternatively disposed among them. Of course, embodiments comprising capacitors, half-cells, monocells, fullcells or bicells are suitable for the usage of the reference electrode assembly 1.

Advantageously but non limiting, the first electronically insulating layer 3 and/or the second electronically insulating layer 4 is made of polymeric microporous membranes, in particular, made of separator S material for the electrochemical energy storage device 2.

In particular, the first electronically insulating layer 3 and/or the second electronically insulating layer 4 are made of, but are not limited to, the porous polymeric separators S conventionally used in LiBs, i.e., polymeric (micro) porous membranes, such as polypropylene polyethylene membrane and multilayer thereof (examples of these separators are those supplied by Celgard® for battery applications, e.g., Celgard 2500), as well as metal-ion conducting polymers (e.g., Nafion in its various forms, sulfonated poly-ether-ether-ketone, SPEEK, among many others) and other materials used for the fabrication of flexible (quasi) solid-state batteries.

Advantageously, the reference electrode 5 comprises in turn a first part of active material (e.g., LFP and LTO), namely a metal ion (e.g., Li+) intercalating/deintercalating material, in particular, that undergoes a two-phase transition under ion intercalation/deintercalation processes at a potential inside the stability window of the battery (i.e., the device 2) electrolyte.

According to some non-limiting embodiments, active materials for reference electrodes 5 (for LiBs) include, but are not limited to, Li-containing phosphate, e.g., olivine lithium iron phosphate (LFP) and Li-containing oxide, e.g., spinel lithium titanate (LTO), as well as their C-coated forms. In particular, by undergoing a two-phase transition under Li⁺ intercalation/deintercalation processes, these materials show stable and constant equilibrium potentials, especially when they are at 50% SoC, namely state of charge (i.e., with the amount of intercalated Lit corresponding to half of the theoretical maximum capacity value). In addition, both LTO and LFP have reaction potentials (1.5-1.6 and 3.4-3.5 V vs. Li/Li⁺, respectively) located inside the stability window of common Li-ion battery electrolytes, e.g., ethylene carbonate (EC):ethyl methyl carbonate (EMC) electrolytes, among many others.

Additionally, the reference electrode 5 comprises a second part of graphene-based conductive component and other electrically conductive components (e.g., graphene derivatives, carbon nanotubes and carbon black) to provide electrical conductivity of the reference electrode 5 at least one order of magnitude higher than the one of the cell electrolyte.

Moreover, reference electrode 5 comprises a third part of binding component configured to withstand the electrochemical environment of the cells. In particular, the binding component is made of binder materials, including those commonly used as the binder for the formulation of battery electrodes. Examples of binders include but are not limited to polyvinylidene fluoride (PVDF), poly(vinylidene fluoride-co-hexafluoropropylene) (PVDF-HFP), polyphenylsulfone (PPSU), carboxymethyl cellulose (CMC), styrene-butadiene rubber (SBR), poly(styrene-butene/ethylene-styrene), poly acrylic acid (PAA), ion-conducting polymers, e.g., sulfonated tetrafluoroethylene-based fluoropolymer-copolymers (i.e., Nafion and its modified forms such as lithiated Nafion) and SPEEK, as well as mixture and copolymers (e.g., polyolefin grafted acrylic acid copolymer) thereof. Among the polymeric binders, PVDF, PVDF-HFP, CMC and CMC/SBR mixtures are preferably used as binder materials because of their dimensional stability in battery electrolytes (e.g., EC:EMC ones), avoiding swelling issues that may interfere with the battery cell operation by causing internal mechanical stresses.

According to some preferred embodiment, the third part of binding component has a content equal to or less than 40 wt %, preferably between 2.5 wt % and 30 wt % (referring to the total weight of the reference electrode 5). Excessive content of the binding components above 40 wt % would passivate the active materials and will deteriorate the electrical conductivity of the reference electrode, causing unstable reference electrode potentials and insufficient characteristic frequency (f_{C}) (lower than 10 kHz) and excessive ohmic losses during dynamic conditions. Also, the porosity of electrode 5 would be compromised (<20%), leading to insufficient R_{EL}, and, thus, excessive ohmic losses during dynamic conditions or even ion blocking effects. A too low content of the binding component below 2.5 wt % would results in insufficient mechanical properties/processability, leading to unstable performances or reference electrode deterioration over battery life.

In particular, the incorporation of graphene in the conductive component permits reference electrode 5 thin film to have an electronic conductivity much higher (at least by one order of magnitude) than the electrolyte conductivity (typically ˜0.01-0.1 S cm⁻¹). By considering this specification and the micro/mesoporosity of the reference electrode 5, the latter can be modelled as an ultrathin mesh-like electrode. In this way, the ions can either travel in the electrolyte of device 2 through the pores of the electrode or be subject to oxidation and reduction reactions at the surface of the active materials. In fact, the porosity of the graphene-based reference electrode 5 ensures negligible ion blocking effects, being the ion pathway not distorted over excessive spatial scales as those occurring for meshes with bulky wires having diameters typically greater than 10 μm. In other words, reference electrode 5 avoids the use of bulky and heavy metallic current collectors, whose non-porous wires would inevitably alter the normal operation of a cell battery by introducing ion blocking effects when placed between the cell electrodes.

In particular, according to the mesh-like electrode model, the impedance contribution of the reference electrode thin-film and electrolyte in its pores (Z) is therefore calculated as:

$$Z = \frac{1}{1 + i ω τ {R}_{EL} / ( {R}_{CT} + {R}_{EL} )} \times \frac{{R}_{CT} \cdot {R}_{EL}}{{R}_{CT} + {R}_{EL}} \qquad eq . ( 1 )$$

wherein, R_{CT} is the charge transfer resistance of the electrode 5, R_{EL} is the resistance electrolyte inside the electrode pores, and τ is the reference electrode thin-film characteristic time constant (given by the product between R_{CT} and the electrode capacitance —C—). Noteworthy, the as-modelled reference electrode impedance is the one of a resistance-capacitor (RC) circuit with a characteristic frequency (f_{C}) given by:

$${f}_{C} = \frac{2 π}{τ {R}_{EL} / ( {R}_{CT} + {R}_{EL} )} \qquad eq . ( 2 )$$

In detail, to reach high f_{C} (e.g., >10 kHz needed for common EIS analysis of battery half-cells), R_{EL} is to be reduced, as permitted by the sufficient porosity (>10%) of the reference electrodes 5. In addition, the impedance of the reference electrode 5 thin film in DC mode (Z_{DC}) is given by:

$${Z}_{DC} = \frac{{R}_{CT} \cdot {R}_{EL}}{{R}_{CT} + {R}_{EL}} \qquad eq . ( 3 )$$

In detail, Z_{DC} should also be minimized to reduce ohmic losses of the battery cell at high C-rate operation, as permitted by the reference electrodes 3. As shown hereinbefore for some embodiments, R_{EL} can be extrapolated by measuring the high-frequency resistance of symmetric cells through EIS measurements. In this case, electrodes can be made by simple metallic foils (e.g., stainless-steel, Al and Cu). Instead, R_{CT} and τ can be calculated from EIS analysis of symmetric cells using two reference electrode 5 thin films deposited on conventional metallic current collectors (e.g., Al and Cu) rather than on separators S.

Preferably, the reference electrode 5 is adhered, in particular, printed or laid down, directly on the first electronically insulating layer 3.

According to some preferred embodiment, the reference electrode has a thickness equal to or less than 200 μm, in particular equal to or less than 100 μm, more in particular equal to or less than 50 μm. In detail, exploiting the two-dimensional properties of graphene, it is easier to reach those reduced thicknesses.

Advantageously but not limitatively, the first part of active materials is between 15% and 85% by weight, in particular between 25% and 65% by weight. In other words, the content of the active materials in reference electrodes 5 is between 15 and 85 weight percentage (wt %), preferably between 25% and 65%, relative to the total weight of the three solid components composing the reference electrode 5.

An excessive content of active materials beyond 85 wt % would result in insufficient electrical conductivity of the reference electrodes 5, leading to insufficient charge transfer resistance of the electrode (R_{CT}), and thus insufficient characteristic frequency f_{C} (<100 kHz) and excessive ohmic losses (>10 mV) during dynamic conditions. Too low content of active materials (lower than 15-20 wt %) would results in the unstable potential of the reference electrodes, since they would easily drift because of pronounced SoC modifications occurring in presence of parasitic currents (current leakage).

According to some preferred and non-limiting environment, the second part of graphene-based conductive component comprises graphitic particulates in form of flakes with aspect ratios of length to thickness and width to thickness greater than five. In particular, there is no upper limit on the length to thickness and width to thickness aspect ratios of a flake. In detail, said graphitic particulates comprise single-/few-layer graphene and multi-layer graphene, as defined in ISO/TS 80004-13:2017 standard, which lists terms and definitions for graphene and related two-dimensional (2D) materials, and includes related terms naming production methods, properties and their characterization. The so-referred graphene can be produced through the exfoliation of graphite crystals, thus by breaking the van der Waals bonds between the graphite layers to separate single/few/multi sp²-hybridized carbon layer of the starting graphite. These exfoliation methods do not alter the crystal structure and chemical properties of the basal planes of the graphite layers, leading to graphene here denoted as “pristine”. In particular, pristine graphene refers to graphene in its original, pure (i.e., unoxidized) form, which endows superior properties to its oxidized counterpart, i.e., graphene oxide, or reduced graphene oxide counterpart, i.e., reduced graphene oxide. Although the latter is obtained by reducing graphene oxide by means of both thermal and chemical processes to restore the sp² character of an atomic-scale hexagonal lattice of pure graphene, it still exhibits structural defects and chemical functionalities that alter the distinctive properties of pristine graphene, including the electrical (e.g., electrical conductivity) and mechanical (e.g., mechanical strength) ones. Therefore, in this disclosure, pristine graphene denotes single-/few-layer graphene and multi-layer graphene that exhibits negligible structural and chemical defects in their basal planes. However, due to the finite dimension of the graphene flakes, structural defects located at the edge sites are accepted in the pristine graphene expression of this disclosure. The type of structural specification of pristine graphene flakes can be assessed by means of Raman spectroscopy measurements.

Preferably, the starting graphite from which pristine are extracted exhibits an atomic percentage content (at %) of O and other elements inferior to 2%, preferably inferior to 1%, more preferably inferior to 0.5% (as measured by X-ray photoelectron spectroscopy), to ensure negligible basal plane defects, as assessed by Raman spectroscopy. Preferably, (pristine) graphene is produced by means of wet-jet milling (WJM) exfoliation of bulk graphite, a physical exfoliation method described in Patent Nr. WO2017089987A1, which negligibly introduce O and other elements in the graphitic structures.

According to some preferred embodiment, other carbonaceous materials can be used in combination with the above-described (pristine) graphene for said second part of graphene-based conductive component. These carbonaceous materials include carbon black, activated carbons, carbon nanotubes, and graphene derivatives (e.g., graphene oxide, reduced graphene oxide and other functionalized graphene). Preferably, high-surface area and highly structured carbon black (e.g., Printex-XE2B and XP545 supplied by Orion®, Vulcan XCMAX22 supplied by Cabot Corporation®, Conductex Kultra and 7055 Ultra supplied by Birla Carbon®, SuperP conductive supplied by Imerys®, EC600JD supplied by Ketjenblack®) are used in combination with the above-mentioned graphene to synergistically improve the electrical properties of the reference electrodes 5. In fact, such a carbon black improves the electrical connection of the flakes, filling the void between themselves. Then, graphene flakes act as long (greater than 100 nm)-range electron conducting pathways.

Advantageously but not necessarily, the content of pristine graphene is equal to or greater than 1 wt % (while the maximum limits determined by the minimum amount of the other reference electrode components). Preferably but non-limiting, pristine graphene content is between 5 and 30 wt %, and more preferably is between 10 and 15 wt %.

In particular, the content of other conductive materials of the second part of the reference electrode 5, beyond graphene, is equal to or lower than 30 wt %, preferably between 10 and 15 wt %. In detail, excessive content of graphene and other conductive materials beyond their maximum limit would limit the content of active materials and binding components, leading to unstable reference electrode 5 potentials and poor mechanical properties/processability (e.g., poor adhesion to the separator S, 3, formation of cracks, poor reference electrode 5 film forming ability).

According to some non-limiting embodiment, as illustrated in the attached figures, reference electrode 5 has a rectangular shape.

According to other embodiments, reference electrode 5 has a polygonal or curved shape, in particular, symmetric with respect to a longitudinal axis L of the reference electrode 5.

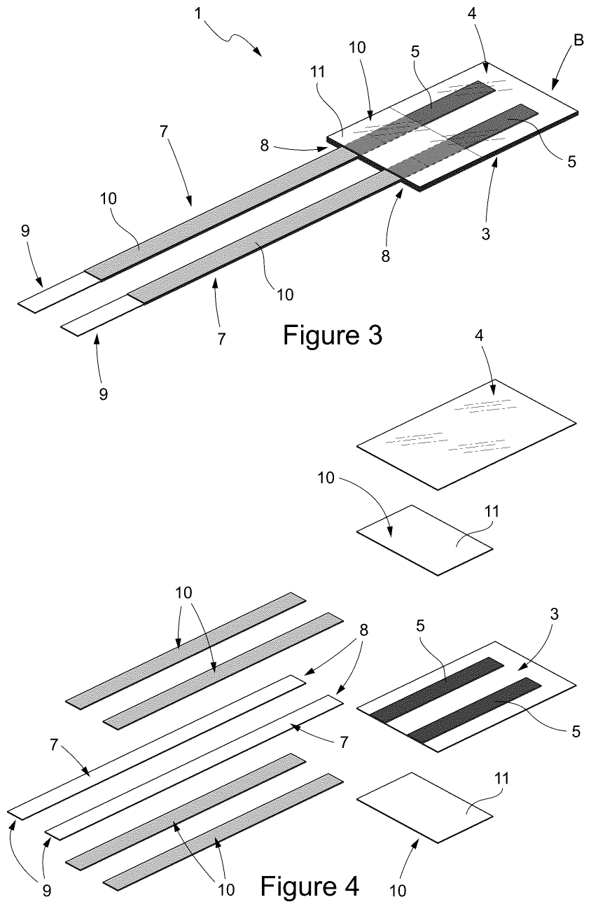

In the embodiment of FIGS. 3 and 4, the reference electrode assembly 1 comprises more than one reference electrode 5, in particular two reference electrode 5. The two reference electrodes 5 can be redundant or can have different compositions and purposes. In any case, everything said in this disclosure remains valid for both reference electrodes 5.

Advantageously but not necessarily, the reference electrode assembly 1 comprises a wiring element 7 (with an oblong shape) configured to connect the reference electrode 5 to the external of the electrode assembly 1 and, thus, of the electrochemical energy storage device 2. The wiring element comprises a proximal end 8 and a distal end 9. In particular, the proximal end 8 is electrically connected to the reference electrode 5 and the distal end 9 is electrically connectable to a battery management system circuitry for the management of electrochemical energy storage device 2.

Preferably, the wiring element is flat.

Preferably, the wiring element is flexible.

According to some preferred embodiment, a thin, eventually flat, and flexible wiring element 7 is comprised by the reference electrode assembly 1 for the electrical connection of the previously disclosed reference electrodes 5 to the external of the electrochemical energy storage device 2. In particular, such a conformation allows to take full advantage of the thin, non-bulky geometry of the disclosed reference electrodes 5. The wiring element 7 is then connected through dedicated circuitry to a BMS. The wiring element 7 allow flat and flexible electrical connection of the reference electrode, which ensures a non-invasive integration of the reference electrodes 5 in common electrochemical energy storage device configurations, including monolayer pouch cells 6, multilayer pouch cells 14, cylindrical and prismatic cells 6. In fact, such electrical connection interferes as less as possible during cell packaging.

In particular, it is important to notice that rigid or too thick connections (i.e., a bulky or cylindrical wire) would cause partial sealing, inducing potential electrolyte leakage and moisture infiltration inside cell 6, compromising the cell's 6 stability and functionalities over time.

According to some preferred embodiment, the wiring element 7, except for the proximal end 8 and the distal end 9 is surrounded by an electrically insulating material 10 to avoid unwanted electrical contacts when the reference electrode assembly 1 is inserted in an electrochemical energy storage device 2. In particular, the insulating material can be a further layer of separators S or polymeric membranes/foils, including strapping tapes (e.g., propylene ones). Because of its simplicity, a strapping plastic tape 11 can be preferred for lab-scale tests.

Examples of wiring element 7 materials are aluminium, copper, nickel, and graphite thin foils. The desired flexibility is achieved by selecting the proper foil thickness.

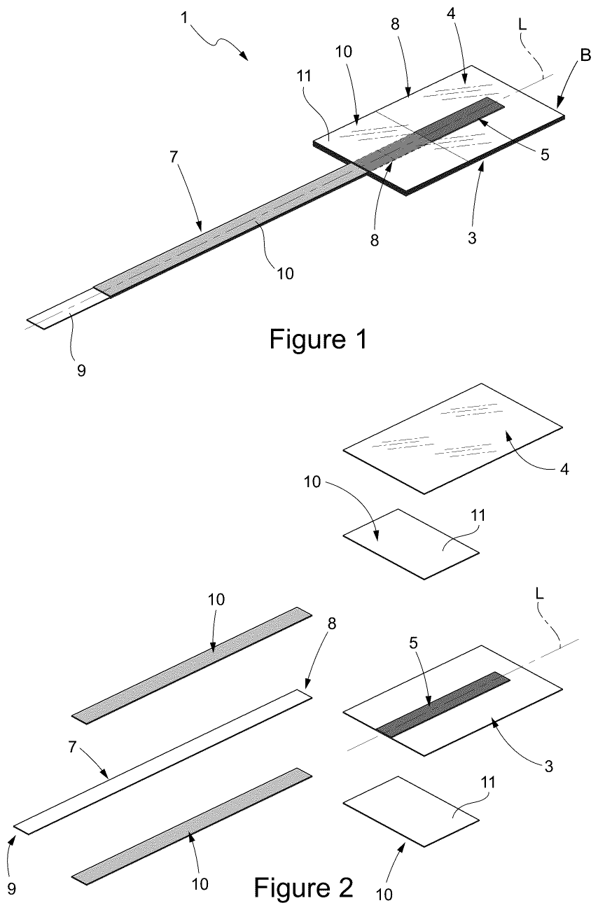

As an example, see FIGS. 1 and 2, wherein the wiring element 7 can be a 5×50 mm pure copper strips (with a thickness of 25 μm) and a set of 2 identical strips of 5×40 mm plastic tape 11 of 0.03 mm-thick propylene or 1 mil-thick Kapton HN (polyimide) are bonded on the upper and lower surface of the copper strip (i.e., the wiring element 7) to ensure electrical and chemical insulation from the surrounding environment (e.g. electrolyte).

Advantageously but not limiting, the thickness of the whole reference electrode assembly 1 is lower than 300 μm, in particular lower than 200 μm, more in particular lower than 160 μm, even more in particular lower than 100 μm.

According to another aspect of the present invention, an electrochemical energy storage device 2 is provided. The electrochemical energy storage device 2 comprises one or more electrochemical cells 6 comprising each at least a first electrode E and a second electrode E facing and parallel to each other as illustrated in FIGS. 5-8.

In particular, for battery stacks, non-terminal electrodes E may be double-sided electrodes (i.e., two electrodes E are deposited on the same current collector) to save space and improve the overall specific performance of the battery stack.

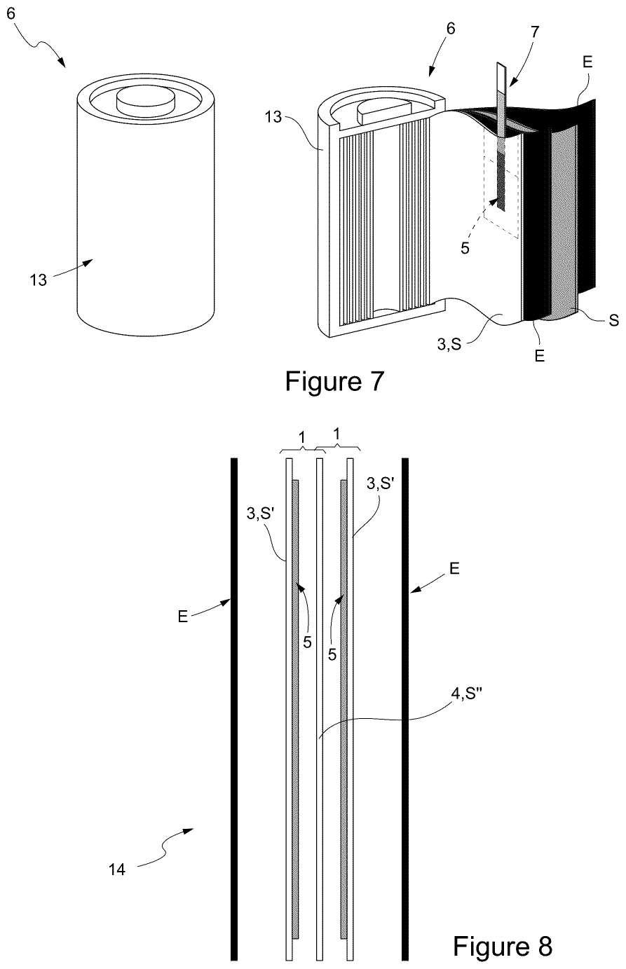

Advantageously, independently of the fact that the cell is a monolayer pouch cell as in FIG. 5, a multilayer pouch cell 6 as in FIG. 6 or a cylindrical cell 6 as in FIG. 7, the electrochemical energy storage device 2 comprises at least one reference electrode assembly 1 according to the present disclosure, wherein the reference electrode assembly 1 is at least partially interposed between the first electrode E and the second electrode E, and wherein the reference electrode assembly 1 has the reference electrode 5 integrally interposed between the first electrode E and the second electrode E (in other words, between a cathode and an anode of a battery cell).

According to a further aspect of the present invention, a method is provided to produce the reference electrode assembly 1 and the electrochemical energy storage device 2.

In particular, the method comprises the steps of:
providing the first electronically insulating layer 3 (e.g., via a dedicated conveyor extracting it from a separator S coil that is cut in successive portions);
printing or depositing, upon the first electronically insulating layer 3, the reference electrode 5;
covering entirely the reference electrode 5 with a second electronically insulating layer 4 facing and parallel to the first electronically insulating layer 3.

Preferably, the method further comprises the further steps of:
connecting the wiring element 7 to the reference electrode 5 so as to connect the reference electrode 5 to the external of the electrode assembly 1 and the electrochemical energy storage device 2; in particular, the wiring element 7 being flat and arranged substantially coplanar with the reference electrode 5;
surrounding the wiring element 7, except for the proximal end 8 and the distal end 9 with an electrically insulating material 10 to avoid unwanted electrical contacts of the reference electrode assembly 1 with other parts (e.g., battery electrolyte).

Contrary to the conventional tab welding methods used to connect the metallic current collectors of the cells to terminal tabs, special precautions should be considered for the connection of reference electrodes 5, since the latter is deposited on, or in any case in contact with, temperature-sensitive separators S (i.e., the first or the second electronically insulating layers 3 or 5). If the separators S withstand the temperature of conventional welding methods, these latter can be directly used, and include: ultrasonic bonding, laser welding, resistance welding, and micro tungsten inert gas (TIG) welding, also known as pulse arc welding.

Advantageously but not necessarily, being aware of the risk to burn temperature-sensitive separators S when using the above-mentioned methods, several low-temperature embodiments for the connecting step are herewith disclosed.

The first embodiment is low-temperature thermoplastic welding, wherein an electrically conductive thermoplastic material, covering the proximal end or inserted (e.g., in a self-standing form) between the wiring element 7 proximal end 8 and the reference electrode 5, is melted at a temperature equal or lower than 160° C., namely a temperature compatible with the layers 3 and 4 and then harden upon cooling. Examples of such electrically thermoplastic materials have been reported in Inventor's patent document WO2020/170154. The advantage of this method is that it can be implemented with equipment reported for some of the traditional welding methods above-mentioned, including ultrasonic bonding.

As a variant of the first embodiment, the connecting step comprises melting the electrically conductive thermoplastic material (polymers of the separators S) in a solvent and applying, between the wiring element 7 proximal end 8 and the reference electrode 5, a resulting ink/paste acting as a glue when the solvent evaporates. The inks and pastes can be directly produced by properly mixing thermoplastic polymers with electrically conductive materials, as described in Inventor's patent document WO2020/170154.

Another embodiment for the connecting step comprises applying a curable thermosetting electrically conductive adhesive between the wiring element proximal end 8 and the reference electrode 5 and curing said thermosetting electrically conductive adhesive so as to let a respective polymerization process occur. In particular, the curing temperature of the adhesive, at which the polymerization processes occur, has to be compatible with the temperature to which the separator S withstands (i.e., lower than 160° C.).

A further embodiment for the connecting step comprises the mechanical stacking of the wiring element 7 proximal end 8 and the reference electrode 5 and applying the plastic tape 11 (e.g., a strapping tape) which mechanically holds the proximal end 8 in contact with the reference electrode 5. As previously mentioned, because of its simplicity, this embodiment can be preferred for lab-scale tests.

In all the embodiments disclosed above, all joining processes between the proximal end 8 and the reference electrode 5 remain at a temperature lower than those reached by traditional welding methods (usually above 300° C. or even 400° C.), avoiding the damaging of temperature sensitive components, including some of the materials composing the reference electrodes 5 above discloses.

As illustrated by the non-limiting embodiment of FIG. 9, the ink/paste is printed/deposited by a printing/deposition head 16 upon a rigid support 15. In some cases, the deposition head 16 is movable and actuated in order to determine the shape of the reference electrode 5; alternatively, or additionally, the support 15 and therefore the first electronically insulating layer 3 is movable. In particular, ink-jet printing (as schematically illustrated in FIG. 9), stencil printing and screen-printing (e.g. Doctor Blade) techniques ware suitable for the deposition of the reference electrode 5 upon the separator S. 3. In these latter cases, the deposition head 16 can be replaced by a deposition (even manual) device, e.g. a container containing the ink/paste, which is spilled on the support 15 (through an appropriate mesh/matrix).

As illustrated in FIGS. 5, 6 and 8, for prismatic or pouch cells 6, the separator S (i.e., the first electronically insulating layer 3) with the tabbed reference electrode(s) 5 and the second electronically insulating layer 4 are placed between the (tabbed) cell electrodes E using a stacking machine, forming a stack 12 can also contain multiple single cell assemblies, possible based on double-sided cell electrode E. The cell stack is commonly inserted in a pouch bag (know and therefore not illustrated) or a rigid metallic case. The pouch bag is typically formed by Al-laminated films. The sides of the bag are joined together through heat sealing, leaving one side open. An electrolyte filling system can be used to add the liquid electrolyte into the cell. Then, the cell is sealed (using a vacuum sealing machine for the pouch cell), and the cell assembly is complete. The bag or metallic case will protect and hold together the components, while providing electrical contact points to connect the cell electrodes and reference electrodes to the external circuitry.

As illustrated in FIG. 7, for the cylindrical cells, cell winding machines are used to wind strips of the (tabbed) cell electrodes, sandwiching the separator S (i.e., the first electronically insulating layer) with the tabbed reference electrode(s) 5 and the second electronically insulating layer 4, into the cell 6 core. By using a grooving machine, the cell 6 case 12 is grooved, fixing the location of the battery core for later sealing. Welding machines are then used to perform the welding of the electrode tabs to the case 12 cap. The case is filled with electrolyte in a vacuum/globe box using an electrolyte filling system. Lastly, a can crimping machine is used to crimp the top cap on the case's 12 top.

In the conventional cell, the preconditioning treatment refers to a formation step, in which solid/electrolyte interphase (SEI) at the anode/electrolyte interface and cathode electrolyte interphase (CEI) at the cathode/electrolyte interface are formed by charging cell 6 for the first time (or during the first charge/discharge cycles). Importantly, SEI and CEI act as passive (electrochemically inert, electronically resistive and ionically conductive) porous layers, that protect the anode and cathode by preventing the electrodes from undergoing subsequent degrading reactions.

For similar reasons, the method also comprises a formation step for the reference electrodes 5 to ensure long-term stable equilibrium potentials.

According to some embodiments, electrode preconditioning is performed before mounting the reference electrode 5 into cell 6 (ex-situ method), by cycling the reference electrode according to methods reported for battery electrodes in prior arts. More in detail, to form such passive layers with adequate characteristics, electrode 5 must be completely wetted by the electrolyte. Since the materials composing common separators S and binders have low electrolyte affinity (e.g., surface energy at 20° C. is ˜35 mN m⁻¹ for polyethylene and ˜30 mN m⁻¹ for polypropylene and PVDF), a period between 12-24 hours under vacuum is preferable implemented to permit the electrolyte to fill the pores of both electrode 5 and separators 3 and 4 before the formation step.

The formation step generally proceeds through different methods, including two-step current-charge formation, pulse formation, controlled ageing process at elevated temperature, as well as combinations thereof. The pre-treated reference electrodes 5 can be therefore used to assemble the cells.

Nevertheless, such a strategy intrinsically modifies the conventional cell 6 manufacturing protocols, since the reference electrode-covered separators 3 will be already wetted, and mechanical stresses occurring during cell 6 assembly may also change the properties of the pre-treated electrodes 5.

Therefore, pre-conditioning processes of the reference electrodes in assembled cells (in-situ methods) are considered preferable in the present disclosure.

More in detail, the method to produce an electrical energy storage device 2 comprises the assembly of cells 6 as previously disclosed and the subsequent conditioning in-situ step of the reference electrode 5.

The in-situ pre-conditioning step comprises bringing the reference electrodes to their 50% SoC by cycling them with respect to the anode or cathode of the battery, depending on the reference electrode 5 formulation. In particular, if the reference electrode 5 comprises active materials commonly used for anodes, the pre-conditioning involves first their metal ion intercalation (e.g., lithiation for LiB reference electrodes), followed by a metal ion deintercalation (e.g., de-lithiation for LiB reference electrodes) until bringing the reference electrode to its 50% SoC, and cell 6 cathode is used as the counter electrode. Vice versa, if the reference electrode 5 is made of active materials commonly used for cathodes, the pre-conditioning involves first the metal ion de-intercalation (e.g., de-lithiation in LiB reference electrodes), followed by a metal ion intercalation (e.g., lithiation in LiB reference electrode) until bringing the reference electrode to its 50% SoC, and cell anode is used as the counter electrodes.

Depending on the cell 6 electrodes' E chemistry, which determines the charge needed for their formation processes, the capacity of the cell 6 electrode E used as the counter electrode may be oversized compared to the capacity of the other cell electrode E, so that the capacity excess can be used for the formation processes of the reference electrodes 5 (meanwhile, the formation process of the counter electrode also occurs partially). Typically, reference electrode 5 is designed to be smaller than cell electrodes E, so that the capacity of the reference electrode 5 is significantly smaller than the capacity of cell electrodes E.

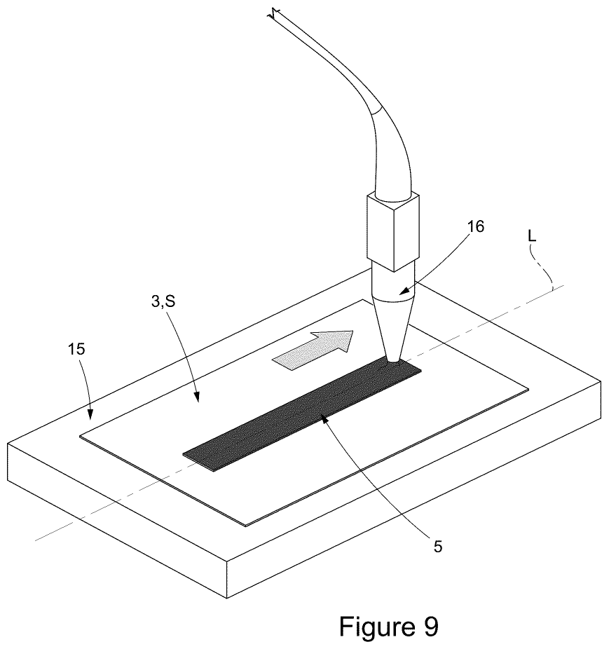

As an alternative to the just mentioned step, two different electrodes 5 (as in the case of the embodiment of FIG. 8) using different active materials can be used to perform their formation step reciprocally, using processes reported for cell electrodes E for conventional battery cells (without any reference electrode).

In particular, according to the non-limiting embodiment of FIG. 8, one reference electrode 5 uses an active material commonly used in anodes, while the other reference electrode uses an active material commonly used for cathodes. By doing so, as previously mentioned, the formation process of the former involves first the metal ion-intercalation (e.g., lithiation for LiB reference electrodes), while the second reference first involves the metal-ion de-intercalation (e.g., de-lithiation for LiB reference electrodes).

Preferably, to minimize the resistance associated with the electrolyte, the reference electrodes 5 are printed on two different separators S′, S″, 3 to be arranged facing each other (see FIG. 8) while being separated by a third separator S′″, 4.

In general, the in-situ pre-conditioning of the reference electrodes 5 has the advantage of not altering the traditional cell fabrication protocols used by battery manufacturers, and only the modification of the electrode formation protocols can be considered.

In particular, during cell 6 operation, the restoring of SoC of the reference electrode 5 can be further considered by cycling the reference electrode versus the anode or cathode, or the other reference electrodes, managing to not overcharge/overdischarge any cell electrode E.

Possibly, additional reference electrodes 5 (buffer electrodes) can be printed onto the cell separator following the procedure described for the disclosed reference electrodes. These buffer electrodes can be used to perform the restoring of the reference electrodes 5 without risking overcharge/overdischarge of the cell anode, cathode and reference electrodes 5.

Although the above-described invention makes particular reference to very specific embodiments, it is not to be considered limited to that example of implementation, falling within its scope all those variations, modifications or simplifications covered by the appended claims.

The reference electrode assembly 1, the electrochemical energy storage device 2 and the relative production method involve numerous advantages.

First, they ensure the accurate monitoring of cathode and anode potentials distinctively in both static and dynamic conditions (the latter requires the minimization of Ohmic losses and the absence of the ion blocking effect).

Additionally, the measurements of artefact-free of EIS spectra of the half-cells are allowed.

Furthermore, compatibility with high-throughput manufacturing processes is ensured.

Moreover, normal cell operation is guaranteed by excluding non-irrelevant extra impedance contributions, as well as the ion blocking effect, degrading the cell electrodes.

A further advantage lies in the possibility to perform in-situ preconditioning and restoring treatments of reference electrode 5 to be used in innovative BMS ensuring long-life cell requirements.

In addition, another advantage lies in the relatively simple implementation into currently available battery cell configurations, including commercial ones (e.g., pouch, cylindrical and prismatic cells).

Finally, the herewith disclosed reference electrode technology avoids degradation effects introduced by previous reference electrode technologies, e.g., the ion blocking effect.

When integrated into BMSs, the distinctive features of the present technology, enabled by the morphological and structural characteristics of the disclosed reference electrodes 5, enhance the QRL and safety of current battery systems by preventing common degradation processes (e.g., electrode overcharging/overdischarging), which cannot be otherwise controlled in absence of reference electrodes.

In addition, reference electrode 5 technology eliminates issues of previous reference electrodes, i.e.:
the geometric and electrochemical asymmetries causing inhomogeneous current distributions, leading to artefacts in EIS measurements
uncontrolled Ohmic losses in dynamic conditions, which impede the reliable monitoring of the cell electrode potentials
local degradation effects, caused by the presence of bulky components composing reference electrodes, which results in mechanical stresses (inhomogeneous pressure distribution), as well as alter the ion transport (ion blocking effect)
instability of the equilibrium potential of the reference electrodes as a consequence of the insufficient amount of active materials or alteration of the chemical state of metallic components (e.g., Li).

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

### Example 1

Representative reference electrodes were produced according to some embodiments of the present invention, obtaining the reference electrode formulation disclosed therein and listed in Table 1 together with their electrical resistivity, as calculated by:

electrical resistivity=(sheet resistance)×thickness

The sheet resistance of the reference electrodes was measured using a Jandel RM3000 Test Unit, while the thickness was measured with a contact profilometer (Ambios XP200).

The materials composing the reference electrodes were:
1) graphene, produced through WJM exfoliation of graphite (Patent Nr. WO2017089987A1);
2) carbon black (Alfa Aesar) for the electrically conductive component;
3) C-coated olivine LFP (C wt %=1.45±0.2, MTI Corp.) or spinel LTO (<200 nm, >99%, Sigma Aldrich) as active materials, and PVDF (Solef, Solvay) as the binder.

Experimentally, PVDF powder was first dissolved in 2 mL of NMP under stirring conditions at 70° C. for 2 h. After dissolving the polymer, the WJM-produced graphene and carbon black were added to the PVDF solution, which was cooled down to room temperature while keeping stirring conditions. Separately, the active material (C-coated olivine LFP or spinel LTO) was added to the 3 mL of NMP and ultrasonicated for 20 min. The as-obtained active material dispersion was then added to the previous mixture. The resulting product was homogeneously mixed using a planetary mixer (Thinky, ARE 200, USA) for 10 min at 2000 rpm. Finally, the as-produced paste was stirred overnight at room temperature. The reference electrodes were obtained by depositing their corresponding pastes on one side of the cell separator (Celgard 2500) by Dr Blading using a single-pass deposition protocol and mask defining the shape of the reference electrode, followed by drying at 80° C. Thanks to the use of graphene according to the embodiments of this invention, the reference electrodes are made of homogeneous flexible thin films (thickness ˜50 μm) with electrical conductivity significantly higher (more than one order of magnitude) than that of battery electrolyte used in the performed tests i.e., lithium hexafluorophosphate (LiPF₆) in ethylene carbonate and dimethyl carbonate mixture (EC:DMC 50/50 wt %, electrical conductivity ˜10.1 mS/cm at 20° C., as measured with an SK20T conductivity probe).

TABLE 1
Electrical performances of the produced reference electrode.

| | Component (wt %) | | | | | Resistivity |
|---|---|---|---|---|---|---|
| Ref. | | | | (pristine) | Carbon | (@20° C.) |
| electrode | C-LFP | LTO | PVDF | graphene | black | (Ω × cm) |
| A-1 | 25 | 0 | 25 | 25 | 25 | 0.061 ± 0.004 |
| A-2 | 50 | 0 | 25 | 12.5 | 12.5 | 0.065 ± 0.005 |
| A-3 | 16.6 | 0 | 50 | 16.6 | 16.6 | 0.055 ± 0.006 |
| A-4 | 65 | 0 | 10 | 12.5 | 12.5 | 0.088 ± 0.006 |
| A-5 | 80 | 0 | 5 | 7.5 | 7.5 | 0.250 ± 0.011 |
| B-1 | 0 | 25 | 25 | 25 | 25 | 0.066 ± 0.005 |
| B-2 | 0 | 50 | 25 | 12.5 | 12.5 | 0.109 ± 0.010 |
| B-3 | 0 | 16.6 | 50 | 16.6 | 16.6 | 0.060 ± 0.004 |
| B-4 | 0 | 65 | 10 | 12.5 | 12.5 | 0.256 ± 0.0131 |
| B-5 | 0 | 80 | 5 | 7.5 | 7.5 | 0.981 ± 0.010 |

### Example 2

The long-term stability of reference electrodes 5 in coin cell configuration was assessed by measuring their equilibrium potential after charging them at 50% SoC. FIG. 1a,b shows the equilibrium potentials of representative reference electrodes over time, indicating excellent stability with absolute potential variation rates over 400 h of 19.7 μV/h for A-1, 24.1 μV/h for A-2, 34.2 μV/h for A-4, 36.8 μV/h for B-1, 14.1 μV/h for B-2, 14.4 μV/h for B-4. These data confirm that the reference electrodes display excellent stability of their equilibrium potentials.

### Example 3

The impedance of reference electrodes 5 reported in Example 1 was calculated through EIS measurements, referring to the mesh-like impedance model described above in the embodiment for graphene-enabled high conductivity, printed, flat and flexible reference electrodes. R_{EL} was measured by measuring the EIS spectra of symmetric cells with stainless steel electrodes separator by two Celgard separators. More in detail, two symmetric cells were measured. The first one was assembled with two pristine Celgard 2500 separators, The second one was assembled with one pristine Celgard 2500 (type 1 cell) and one Celgard 2500 fully printed with reference electrodes 5 on the side facing the other separator (type 2 cells). By subtracting the average values of high-frequency intercepts of Nyquist plots of type 2 cells with the average values of the high-frequency intercepts of the Nyquist plot measured for type 1 cells, the average R_{EL} for the reference electrodes used in each type 2 cell was obtained. R_{CT} and C were instead measured by the analysis of EIS spectra obtained for symmetric cells using reference electrodes 5, according to methods reported in the literature.²²

The calculated impedance parameters of the reference electrodes are reported in Table 2. Obtained results confirm that the characteristic frequencies of reference electrodes 5 are satisfactory to carry out reliable EIS measurements up to frequencies >100 kHz.

TABLE 2
Calculated impedance parameters of representative reference electrodes.

| Ref. | R_{EL} | R_{CT} | C | | fc | Z_{DC} |
|---|---|---|---|---|---|---|
| electrode | (Ω · cm²) | (Ω · cm²) | (μF/cm²) | τ (s) | (kHz) | (Ω · cm²) |
| A-1 | 0.58 | 0.74 | 2.33 | 1.11 × 10⁻⁵ | 2291 | 0.325 |
| A-2 | 1.61 | 1.07 | 2.34 | 1.21 × 10⁻⁵ | 2173 | 0.642 |
| A-4 | 0.42 | 1.18 | 2.48 | 3.13 × 10⁻⁵ | 2360 | 0.309 |
| B-1 | 0.52 | 4.04 | 28.70 | 1.56 × 10⁻⁵ | 299 | 0.460 |
| B-2 | 0.54 | 4.18 | 17.45 | 3.54 × 10⁻⁵ | 190 | 0.478 |
| B-4 | 1.52 | 11.73 | 14.12 | 1.68 × 10⁻⁵ | 442 | 1.340 |

The reference electrodes here shown can be used in LiBs to accurately measure half-cell impedance measurements in a frequency range of 0.1 Hz-100 kHz and to reliably monitor the cell electrode potentials over galvanostatic cycling at different C-rate, without significantly affecting the performances (e.g., rate capability) of the cells compared to the control cells without reference electrodes.

1. A reference electrode assembly (1) installable in an electrical energy storage device (2); the reference electrode (5) comprising a planar main body (B), which comprises in turn:
a first electronically insulating layer (3);
a second electronically insulating layer (4) facing and parallel to the first electronically insulating layer (3);
a planar, porous reference electrode (5), which is entirely interposed between the first electrically insulating layer (3) and the second electrically insulating layer (4);
wherein the reference electrode (5) comprises in turn:
a first part of active material, namely a metal ion intercalating/deintercalating material;
a second part of graphene-based conductive component;
a third part of binding component;

2. The reference electrode assembly (1) according to claim 1, wherein the reference electrode (5) is adhered, in particular printed or laid down, directly on the first electronically insulating layer (3).

3. The reference electrode assembly (1) according to claim 1, wherein the reference electrode (5) has a thickness equal to or less than 300 μm, in particular equal to or less than 200 μm, more in particular lower than 160 μm, even more in particular lower than 100 μm, preferably equal to or less than 50 μm.

4. The reference electrode assembly (1) according to claim 1, wherein the first electronically insulating layer (3) and/or the second electronically insulating layer (4) is made of polymeric microporous membranes, in particular made of separator(S) material for electrical energy storage device (2)s.

5. The reference electrode assembly (1) according to claim 1, wherein the second part of graphene-based conductive component comprises graphitic particulates in form of flakes with aspect ratios of length to thickness and/or width to thickness greater than five.

6. The reference electrode assembly (1) according to claim 1, wherein the first part of active materials is between 15% and 85% by weight of the reference electrode (5), preferably between 25% and 65%.

7. The reference electrode assembly (1) according to claim 1, wherein the second part of graphene-based conductive component comprises a content of pristine graphene equal or greater than 1% by weight of the reference electrode (5); preferably, the content of pristine graphene is between 5% and 30%, and more preferably is between 10% and 15%; preferably, the second part comprises other conductive materials beyond graphene in a content equal or lower than 30% by weight of the reference electrode (5), preferably between 10% and 15%.

8. The reference electrode assembly (1) according to claim 1, wherein the third part of binding component is equal or less than 40% by weight of the reference electrode (5), preferably between 2.5% and 30% by weight of the reference electrode (5).

9. The reference electrode assembly (1) according to claim 1 and comprising a wiring element (7) configured to connect the reference electrode (5) to the external of the reference electrode assembly (1); in particular, the wiring element (7) being flat and preferably substantially coplanar with the reference electrode (5); wherein the wiring element (7) comprises a proximal end (8) electrically connected to the reference electrode (5) and a distal end (9), electrically connectable to a battery management system circuitry.

10. The reference electrode assembly (1) according to claim 9, wherein the wiring element (7), except for the proximal end (8) and the distal end (9) is surrounded with an electrically insulating material (10) so as to avoid unwanted electrical contacts when the reference electrode assembly (1) is inserted in an electrical storage device (2) or connected to external circuitry

11. An electrical energy storage device (2) comprising:
at least one electrochemical cell (6), comprising at least a first electrode (E) and a second electrode (E) facing and parallel to each other;
a reference electrode assembly (1) according to claim 1;
wherein the reference electrode assembly (1) is at least partially interposed between the first electrode (E) and the second electrode (E), and wherein the reference electrode assembly (1) has the reference electrode (5) integrally interposed between the first electrode (E) and the second electrode (E).

12. The electrical energy storage device (2) according to claim 11, wherein the first electronically insulating layer (3) and/or the second electronically insulating layer (4) serve as a separator(S) between the first electrode (E) and the second electrode (E).

13. The electrical energy storage device (2) according to claim 11, and comprising a first reference electrode assembly (1) and a second reference electrode assembly (1) facing and parallel to each other between the first electrode (E) and the second electrode (E); in particular, the first reference electrode assembly (1) and a second reference electrode assembly (1) being interspaced by a further separator(S) layer.

14. Method to produce an electrical energy storage device (2); the method comprising the steps of:
providing a first electronically insulating layer (3);
printing or depositing, upon the first electronically insulating layer (3), a reference electrode (5) comprising graphene;
covering entirely the reference electrode (5) with a second electronically insulating layer (4) facing and parallel to the first electronically insulating layer (3).

15. Method according to claim 14 and comprising the further steps of:
connecting a wiring element (7) to the reference electrode (5) so as to connect the reference electrode (5) to the external of the reference electrode assembly (1); in particular, the wiring element (7) being flat and arranged substantially coplanar with the reference electrode (5); wherein the wiring element (7) comprises a proximal end (8) electrically connected to the reference electrode (5) and a distal end (9), electrically connectable to a battery management system circuitry;
surrounding the wiring element (7), except for the proximal end (8) and the distal end (9) with an electrically insulating material (10) to avoid unwanted electrical contacts when the reference electrode assembly (1) is inserted in an electrical storage device (2) or connected to external circuitry.

16. Method according to claim 15 wherein the connecting step is performed by:
thermoplastic welding, wherein an electrically conductive thermoplastic material, covering the proximal end (8) or inserted between the wiring element (7) proximal end (8) and the reference electrode (5), is melted at a temperature equal to or lower than 160° C.; or
melting the electrically conductive thermoplastic material in a solvent and applying, between the wiring element (7) proximal end (8) and the reference electrode (5), a resulting ink/paste acting as a glue when the solvent evaporates; or
applying a curable thermosetting electrically conductive adhesive between the wiring element (7) proximal end (8) and the reference electrode (5) and curing said thermosetting electrically conductive adhesive so as to let a respective polymerization process occur;
mechanical stacking of the wiring element (7) proximal end (8) and the reference electrode (5) and applying a plastic tape (11) which mechanically holds the proximal end (8) in contact with the reference electrode (5).

17. Method according to claim 14 and comprising an assembling step, wherein the reference electrode assembly (1) is interposed between a first electrode (E) and a second electrode (E) of an electrochemical cell (6); wherein the assembling step also comprises wetting the first electronically insulating layer (3) and the second electronically insulating layer (4) with an electrolyte;
the method further comprising a formation step, subsequent to the assembling step, and comprising bringing the reference electrode (5) to substantially half of its state of charge by cycling it with respect to the first electrode (E) or the second electrode (E) of the cell (6), depending on the reference electrode (5) 5 composition.
